(19) United States
(12) Patent Application Publication
(10) Pub. No.: US 2007/0043513 A1
(43) Pub. Date: Feb. 22, 2007

(54) Constructing efficient ecosystems using optimization techniques

(76) Inventor: Frederik P.J. Vandecasteele, Moscow, ID (US)

Correspondence Address: KLARQUIST SPARKMAN, LLP, 121 SW SALMON STREET, SUITE 1600, PORTLAND, OR, 97204, US

(21) Appl. No.: 10/557,859

(22) PCT Filed: May 21, 2004
(86) PCT No.: PCT/US04/16069

§ 371 Date: Nov. 21, 2005

Related U.S. Application Data
(60) Provisional application No. 60/472,980, filed on May 22, 2003.

(51) Int. Cl. G06F 19/00; G06G 7/48; G06G 7/58

(52) U.S. Cl. 702/20; 703/11

(57) ABSTRACT

A method for selecting groups of organisms to perform a predetermined function is disclosed. The method includes using the relative fitness of initial candidate groups of organisms for performing the function to select new groups of organisms that perform the function with greater efficiency than the initial candidate groups. In a working embodiment, a genetic algorithm and fitness testing of groups of organisms selected by the genetic algorithm are used to provide groups of organisms that can efficiently perform the predetermined function.

### CROSS REFERENCE TO RELATED APPLICATION

This claims the benefit of U.S. Provisional Patent Application No. 60/472,980, filed May 22, 2003, which is incorporated by reference herein.

### STATEMENT OF GOVERNMENT SUPPORT

This invention was made in part with support by the United States Army Research Laboratory under contract DAAD 19-00-1-0078, and in part pursuant to a fellowship from the Inland Northwest Research Alliance (INRA) Subsurface Science Research Institute which is funded by the Department of Energy under contract DE-FG07-02ID14277; the United States government has certain rights in the invention.

### BACKGROUND

Ecology is the field within biology that studies the interactions of organisms with one another and with their physical environment. Ecosystems are made up of communities of organisms and the nonliving factors with which they interact. Such communities typically consist of populations of many different species of organisms that can interact in a highly non-linear fashion. These interactions between members can be advantageous, disadvantageous or neutral for one or more of the particular members of the community. Nonetheless, as a group, a community of organisms can often perform a particular function or task (such as biomass production) better than any individual member of the community alone. For example, one organism might perform the bulk of the function, with other organisms catering to it by producing specific nutrients or by changing the environment so that it becomes favorable for the main organism. Alternatively, different organisms could perform different parts of an overall function, without hampering each other's functioning.

Unfortunately, the interaction of organisms with each other makes it difficult to select a group of organisms to perform a particular task a priori. As a consequence, groups of organisms that are selected to perform a particular task are typically extracted directly from nature or prepared to mimic a naturally-occurring ecosystem. For example, microbial consortia that are selected to perform a certain task (such as remediation of environmental contamination) are typically obtained directly from a site where they are already performing the task (such as a hazardous waste spill site). Although such consortia can be optimized in culture to better perform the task (for example, through application of a selective pressure such as an increased concentration of a hazardous waste component), even with optimization any resulting consortia are constrained to include only those types of microorganisms that were originally present in situ. Thus, such “optimized” consortia are optimal only with respect to the relative abundances of the microorganisms present in the initial samples, and not generally optimal with respect to the members of the consortia. The same would be true of any ecosystem isolated from nature or designed to mimic a naturally-occurring ecosystem.

What is needed therefore is a method of assembling groups of organisms to perform a particular task where the method can take into account the non-linear interactions between organisms and can identify non-naturally occurring combinations of organisms to efficiently perform the task. Such a method could, for example, be used to design microbial consortia that more efficiently perform a given task than naturally-occurring microbial consortia.

### SUMMARY

A method is disclosed that can be used to select groups of organisms to perform an arbitrary, predetermined function. In this method, fitness values for performing the function are measured for the members of a first set of candidate groups of organisms (which groups, for example, can be selected randomly from a larger panel of organisms), where the fitness values are measures of the efficiency with which the different candidate groups perform the function. An optimization technique (such as a genetic algorithm) is then used to derive a second set of candidate groups of organisms from the candidate groups in the first set and their measured fitness values. The fitness values for the candidate groups in the second set are measured, and can be used in the optimization technique to derive a third set of candidate groups from the second set. The process of measuring fitness values for candidate groups and deriving new candidate groups from them with the optimization technique can be repeated any number of times (from one to a thousand or more iterations) before a particular groups of organisms is ultimately selected, based on its measured fitness value, to perform the function.

The foregoing and other features and advantages will become more apparent from the following detailed description of several embodiments.

### BRIEF DESCRIPTION OF THE DRAWINGS

FIG. 1 is a graph showing the maximum, average and minimum amount of growth for different microbial consortia over several successive generations of fitness testing and optimization to obtain consortia exhibiting minimal growth.

FIG. 2 is a graph showing the average presence of particular strains of microorganisms over several successive generations as consortia are optimized to exhibit minimal growth.

FIG. 3 is a graph showing maximum and average biomass production for different microbial consortia over several successive generations of fitness testing and optimization to obtain consortia exhibiting increased biomass production.

FIG. 4 is a graph showing the average presence of particular strains of microorganisms over several successive generations as consortia are optimized to exhibit increased biomass production.

FIG. 5 is a graph showing the average numbers of strains present in microbial consortia over several successive generations as the consortia are optimized to exhibit increased biomass production.

FIG. 6 is a graph showing the increasing fitness exhibited by microbial consortia optimized using the disclosed methods to degrade an azo dye.

FIG. 7 is a graph showing the average numbers of strains present in microbial consortia over several successive generations as the consortia are optimized to degrade an azo dye.

### DETAILED DESCRIPTION

1. Abbreviations

EC—evolutionary computation

ES—evolutionary strategy

GA—genetic algorithm

LB—Luria Bertani medium

OD—optical density

2. Terms

Unless otherwise explained, all technical and scientific terms used herein have the same meaning as commonly understood by one of ordinary skill in the art to which this invention belongs. The singular terms “a,” “an,” and “the” include plural referents unless context clearly indicates otherwise. Similarly, the word “or” is intended to include “and” unless the context clearly indicates otherwise. The term “comprising” means “including”; hence, “comprising A or B” means including A or B, or including A and B. Although methods and materials similar or equivalent to those described herein can be used in the practice or testing of the present invention, suitable methods and materials are described herein. In case of conflict, the present specification, including explanations of terms, will control. In addition, the materials, methods, and examples are illustrative only and not intended to be limiting.

As used herein, the term “organism” refers generally to an animal, plant or microorganism of any type. Examples of organisms include, but are not limited to, trees, grasses, mosses, algae, mammals, marsupials, fish, birds, insects, bacteria, fungi, archaebacteria and viruses. The term organism not only refers to individual organisms, but to particular combinations of organisms. For example, an organism may be a particular plant, animal or microorganism, or an organism may be a group of organisms that occur together, such as a mixture of microorganisms obtained from a soil sample or group of organisms that occur in a symbiotic relationship (such as lichen).

As used herein, the terms “function” or “task” refers to any biological, physical or chemical process, or combinations of such process mediated by an organism or organisms. Functions or tasks include without limitation ecological functions and industrial functions. Examples of ecological functions include, but are not limited to, diversity, biomass production, exploitation of available resources, stimulation of growth of organisms, inhibition of growth of organisms, nutrition. Examples of industrial functions include energy generation, chemical reactions (including biosynthetic, degradative and metabolic pathways), fermentation, bioremediation, biodegradation, self-contained ecosystems, waste recycling etc. An ecological function already may exist in nature, or be designed based on a predetermined goal. For example, the ecological function may be a new process or pathway that produces a product (new or old), or a new approach to an existing process or pathway.

As used herein, the terms “fitness level” or “fitness value” refer to a qualitative or quantitative measure of the suitability of a group of organisms for performing a predetermined ecological function. In other words, these terms refer to the degree to which a particular group of organisms solves the problem for which a solution is sought. A fitness level may be measured experimentally (for example, the biomass production in a period of time, such as a period of minutes, days, weeks, months or years), and/or may be calculated from experimental and/or theoretical data.

As used herein, the phrase “group of organisms” refers to two or more organisms. The term can further refer to the relative amounts (or numbers) of each of the organisms in the group, and further to a time sequence of introduction of the organisms in the group into a sample. For example, one group of organisms could include organisms A, B and C in equal amounts or numbers. A second group of organisms could include organisms A and B in equal amounts and organism C in one-half the amount of organisms A and B. A third group of organisms could include equal (or unequal) amounts of organisms A, B and C introduced into a sample at 6 hour intervals in a specified order, for example, A first, B six hour later, and C six hours after B.

3. Overview

The disclosed methods of constructing artificial ecosystems can be used to select sets of organisms that optimally perform arbitrary, pre-determined functions. In some embodiments, the methods involve selecting (such as randomly from a panel of organisms) and constructing an initial population of several different groups of organisms that may perform a particular function. The different groups of organisms that are initially constructed are tested for their ability to perform the function as a group, and fitness values that reflect the relative efficiency of the different groups in performing the function are measured. A second population of different groups of organisms is selected using an optimization technique, which uses the groups in the initial population and their fitness values to select groups for inclusion in the second population. The different groups of organisms in the second population are assembled and fitness tested to determine their fitness values. In one embodiment, one or more groups of different organisms in the second population that show higher fitness values than the groups in the initial population are selected to perform the function. In another embodiment, the groups of different organisms in the second population and their fitness values are used in an optimization technique to select a third population of different groups of organisms, which can be fitness tested and used to derive a fourth population, and so on. These steps can be repeated through any number of subsequent populations. In a particular embodiment, the organisms are isolated microorganisms that are combined to provide groups of microorganisms (microbial consortia) that are fitness tested. It is not necessary that organisms used to construct groups of organisms be identified to practice the method. Furthermore, the “organisms” can themselves be combinations of organisms, for example, separate microbial consortia obtained from different soil samples.

Selection of new candidate groups of organisms from fitness-tested groups of organisms may be performed by any optimization technique, including evolutionary computation, evolutionary programming, evolution strategies, genetic algorithms and combinations thereof. Optimization techniques also include gradient descent, neural networks (or kernel based learning techniques in general), interpolation, tabu search, particle swarm optimization, simulated annealing, fussy logic and direct analytical discovery. Evolutionary computation (EC) refers to a problem-solving system that uses computational models of the evolutionary process as elements in design and implementation. A number of evolutionary computational models exist, including, for example, evolutionary algorithms (including genetic algorithms), evolution strategies, evolutionary programming and artificial life. [See, for example, Holland, J. H., “Adaptation in natural and artificial systems: an introductory analysis with applications to biology, control, and artificial intelligence,” University of Michigan Press, Ann Arbor Mich., 1975; Goldberg, D. E., “Genetic algorithms in search, optimization, and machine learning,” Addison-Wesley, Reading Mass., 1989; Koza, J. R., “Genetic programming: On the programming of computers by means of natural selection,” MIT Press, Cambridge, Mass., 1992; T. Bäck, D. Fogel and Z. Michalewicz, editors, “Handbook of evolutionary computation,” IOP Publishing and Oxford University, New York 1997; Fogel, D. B., “An introduction to simulated evolutionary optimization,” IEEE Transactions on Neural Networks, 5: 3-14, 1994; and Spears et al., “An overview of evolutionary computation,” Proceedings of the 1993 European Conference on Machine Learning,” 442-459, 1993, all of which publications are incorporated by reference herein.]

An evolutionary algorithm (EA) is an algorithm which incorporates aspects of natural selection or survival of the fittest. An evolutionary algorithm maintains a population of structures (usually initially random), that evolves according to rules of selection, recombination, mutation and survival, which are referred to as genetic operators. A shared “environment” determines the fitness or performance of each individual in the population. The fittest individuals are more likely to be selected for reproduction (retention or duplication), while recombination and mutation modify the reproduced individuals, yielding potentially superior ones. EAs are one kind of evolutionary computation and differ from genetic algorithms.

A genetic algorithm (GA), which is a type of evolutionary algorithm, generates each individual from some encoded form known as a “chromosome” or “genome.” For example, a particular chromosome may represent a particular combination of organisms. “Crossover,” the kind of recombination of chromosomes found in sexual reproduction in nature, is also often used in GAs. In this approach, an offspring's chromosome may be created by joining segments chosen alternately from each of two parent's chromosomes, which are of fixed or variable length. Genetic algorithms are described in detail in Goldberg, “Genetic Algorithms in search, optimization, and machine learning,” Addison-Wesley Pub. Co., Reading Mass., 1989, which is incorporated herein by reference.

Evolution strategies (ESs) are a kind of evolutionary algorithm where individuals (potential solutions) are encoded by a set of real-valued “object variable” (i.e. the individual's genome). For each object variable an individual also has a “strategy variable” which determines the degree of mutation to be applied to the corresponding object variable. The strategy variables also mutate, allowing the rate of mutation of the object variables to vary. An ES is characterized by the population size, the number of offspring produced in each generation and whether the new population is selected from parents and offspring, or only from the offspring. [See, for example, Rechenberg, “I. Evolutionstrategie: Optimierung Technisher Systeme nach Prinzipien des Biologischen Evolution,” Fromman-Hozlboog Verlag, Stuttgart, 1973; Schwefel, H. P., “Numerical optimization of computer models,” John Wiley & Sons, New-York 1981 and Beyer, H. G. and Schwefel, H. P., “Evolution strategies: A comprehensive introduction,” Natural Computing, 1(1):3-52, 2002, both of which publications are incorporated by reference herein.

In working embodiments, a genetic algorithm is used to construct microbial consortia from particular microbial species, strains or isolates to perform arbitrarily chosen ecological or industrial functions (tasks). In general, the approach can optimize systems with high levels of interaction between members of the consortia, and can identify the parameters that govern the ecological function. In this approach, an “individual” is a group of organisms selected from a panel of microorganisms and is represented by a “chromosome.” Such groups of microorganisms may include one or more of the panel microorganisms. In one embodiment, the chromosome representing an individual is a set of values denoting the presence or absence of particular panel microorganisms in the group. For example, presence of a particular microorganism in a group may be denoted by a “1” appearing at a particular position in a string of values, and absence of the particular microorganism in a group denoted by a “0” appearing at the particular position. In other words, a “chromosome” for each different group that represents a potential solution for performing the ecological function can be a string of values that indicates which of the panel microorganisms are included in the individual solution. Chromosomes can further encode information about the relative or amount (number) of the organisms in the group and/or the sequence in which the organisms in the group are introduced into a sample or system.

In some embodiments, a random initial population of individuals (e.g., different groups of organisms that may or may not optimally perform a predetermined ecological function) is generated. The fitness levels (fitness values) of the individuals, which are proportional to the degree to which the individuals meet the objective of performing the desired ecological function, are determined. Selection of particular individuals that will be used to form a second generation of individuals is performed, where the probability of selecting an individual is proportional to its fitness. Crossover is then used to exchange pieces of the chromosomes representing the selected individuals and mutation is used to randomly change the values in the chromosome. Crossover and mutation yield a second generation of individuals for which fitness levels are determined, and the process is repeated to evolve a population (generation) of individuals (e.g. groups of organisms) that has improved fitness for performing the ecological function. One or more of the “individuals” in the final generation may be selected and used to perform the desired ecological function. Selection, and crossover and/or mutation can be repeated for as many times as is desired, determined by such factors as suitable or optimized performance of the desired function, practicality, economic considerations, and combinations thereof.

Many suitable genetic algorithms exist for use in the disclosed method, and differ in their approach and/or parameters and ranges of values for these parameters. For example, chromosome length, which corresponds to the size of the set of source organisms from which candidate groups are selected, may vary from a few to several hundreds or thousands. Genetic algorithms may be of the generational type where the entire population is replaced in each successive generation, or steady state where populations overlap between successive generations. Selection of individuals for creating successive iterations of the genetic algorithm may be based upon a roulette wheel scheme or a rank-based scheme (such as tournament selection). Fitness values used for selection of individuals may be rescaled in any manner, for example, linearly, exponentially, quadratically, etc. The type of cross-over used may be single point, multiple-point (such as two-point or three-point), uniform, or involve inverting pieces of chromosomes and/or changing the location of certain pieces of chromosomes. Crossover frequency may vary from 0%-100%, but is typically high, such as 80% or greater, or 90% or greater. Mutation can be of several types, including but not limited to, fixed % chance per bit (such as a value indicating whether a particular organism is in an “individual” or group) or fixed % chance per bitstring (such as the set of values that represents an individual group or organisms). The mutation frequency may vary from 0% to 100%, but is typically low, such as from 0-5%, for example, from 1-2%. Mutation may be performed by switching values between possible values (e.g. from 0 to 1 or 1 to 0), or mutation may be performed by assigning a random new value to the bit to be mutated (e.g. from 0 or 1 to 0 or 1). The number of generations (or iterations) used in the genetic algorithm may vary from a few to several hundreds of thousands or millions. Typically, the algorithm may be stopped when successive generations no longer continue to show significant improvements in the fitness values of the individuals they contain, or when a desired production, remediation, economic limit or combinations thereof are met. The population size, i.e. the number of individuals that are considered, may be anything from a few to several hundreds, thousands, or millions, and can vary from generation to generation.

When considering representation of candidate groups of organisms, it's possible to distinguish three main types of group assembly, each of which can be optimized using EC. The most straightforward method of assembly is combining fixed amounts of different organisms together at one single point in time. A bit string, encoding for the presence or absence of corresponding organisms can be used to represent the group. An elaboration on this basic idea is to allow the number or amount of organisms of each species to be added to an ecosystem to vary. Such groups can also be represented as bit strings, with subsections of the strings mapping to amounts of organism, or as a string of integer or real values. Alternatively, rather than having all organisms combined at one point in time, a third type of group defines the points in time at which each species is added to the ecosystem and thus also the sequence of additions, which also can be encoded as bit strings. In summary, a group may be represented by any combination of information on what organisms are present, in what amounts they are present, and when they are added to a system.

Where groups of microbes are selected to perform an ecological function, groups of microbes may be tested for their fitness level in separate cultures. If this is the case, it is also possible to optimize not only the members of the groups of microorganism, but the culture medium itself. Alternatively, it may be possible to identify optimal consortia for one or more of the different media used.

The disclosed method may be applied, non-exclusively, to provide groups of organisms for performing the following ecological functions. In general, increased performance from existing human-controlled, biologically-mediated processes or establishment of new processes may be realized with the disclosed method. For example, the method may be applied to agriculture or aquaculture where the method may be used to find groups of crops and/or animals (as opposed to monoculture currently often used) that can be efficiently grown together, for example, using the same cultivation regime (intercropping). The disclosed method also may be applied in the fermentation industry where consortia, or mixed cultures, may be identified that provide better yields or novel processes. In bioremediation, the disclosed method may be used to provide new groups of organisms that degrade certain contaminants (such as mixed wastes, petroleum hydrocarbons, TNT, PCBs, azo dyes and various other chlorinated compounds including pentachlorophenol and tetrachloroethylene) faster than currently possible with isolated/enriched environmental cultures, or provide a group of organisms that can degrade contaminants previously resistant to bioremediation. Both in situ and bioreactor applications are possible. Furthermore, the disclosed method may be used to design self-contained ecosystems, for example, biospheres for nutrition/energy generation/waste recycling during extended missions in space. The disclosed method may also be utilized to study relationships between ecosystem function and composition. For example, the relationship between potential maximal richness and richness level with the highest productivity or the relationship between ecosystem resources versus maximal productivity and optimal diversity may be explored with the disclosed method.

4. Examples

The following examples are provided for illustrative purposes, and particular compounds, reagents and methods discussed in these examples should not be construed as limitations of the invention.

### EXAMPLE 1

### Constructing Microbial Consortia Having Minimal Growth

In this example, a genetic algorithm approach is used to construct microbial consortia exhibiting minimal growth, surprisingly, from a set of separate, isolated strains of fast growing microbes. Construction of minimally growing consortia is impossible with classical microbiological enrichment techniques because such techniques are based on a positive selection of faster growing strains under selective conditions.

Microbial isolates with morphologically distinct colony features were obtained by incubating a dilution of a surface layer soil sample on R2A agar and incubating the plates at different temperatures. From these isolates, 20 different fast growing strains were selected that had grown well in an overnight Luria Bertani (LB) broth, as judged by the turbidity of the culture medium. An equal volume of 40% glycerol was added to the cultures (final concentration 20% glycerol), after which the cultures were aliquoted into cryovials and stored at −80° C. The individual strains were not identified.

The GA used in this example followed the generational model and had a population size of 20. Each solution (individual consortium) was represented as a string of 20 bits, encoding the presence (1) or absence (0) of the corresponding microorganism. In this way, each solution (individual) encoded a specific microbial consortium. The first generation was randomly generated. Fitness values were linearly rescaled, with μ′=μ and fₘₐₓ′=2μ. If this yielded negative values, the fitness values were rescaled so that μ′=μ and f′ₘᵢₙ=0. Roulette Wheel selection was used. Whenever at least one parent was selected more than two times, the selection scheme was rejected and selection was repeated. Single crossover was performed on each pair of selected individuals with a probability of 0.90. Mutation was performed by flipping bit values with a probability of 0.01 per bit. Elitism was applied by copying the parent solution with the highest fitness into the next generation. Eight generations in total were evaluated.

The objective of this optimisation effort was to obtain a microbial consortium with minimal growth after 24 hours, composed of fast growing member strains. To evaluate the fitness of the individuals (the separate consortia containing particular strains that are solutions generated by the GA) in each generation, the microbial consortia corresponding to the solutions generated by the GA were assembled and incubated in the lab. First, the separate strains were diluted from their stock vials by adding 20 μL of each vial to 3 mL of LB. The 20 consortia were then constructed in 20 standard glass test tubes by transferring 100 μL of each of the diluted strain samples selected for a particular consortium into the separate 20 consortium tubes. After this, LB was added to the consortium tubes to make up all volumes to 6 mL. Each consortium was separated into three replicate samples by vortexing the consortium tubes and transferring 2 mL to each of two new glass test tubes. This resulted in a final growth medium volume for each experiment of 2 mL. The 60 (3×20) tubes making up one generation were incubated at 37° C. and 200 rpm for 24 hours. Growth after 24 hours was assessed by transferring 200 μL of each test tube to a 96 well microtiter plate and measuring the optical density in each well using an automated spectrophotometric plate reader. Optical density (OD) (dimensionless units) is a measure of turbidity, which is proportional to the amount of microbial cells present in each sample and thus OD constitutes a measure of microbial growth. The fitness value of each individual in the GA was calculated as the inverse of the average optical density value of the corresponding consortium for the three replicates. When a solution encoded for zero consortium members, it received a fitness value of zero (no instances of this occurred). Fitness values measured for the consortia (solutions/“individuals”) of each generation were used by the GA to generate the next subsequent generation.

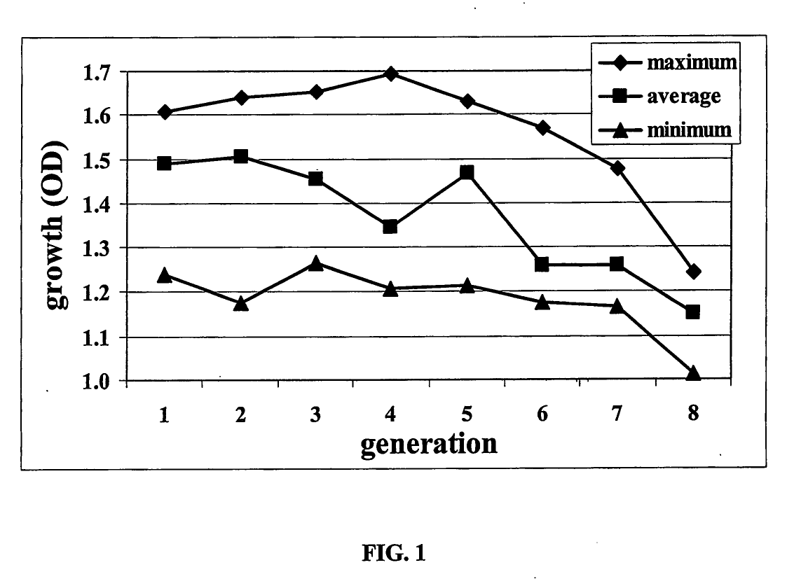

The trends in minimum, maximum and average growth (expressed as OD units) over the 8 successive generations tested are shown in FIG. 1. During the course of these eight generations of optimisation, there was a significant decrease in minimum and overall growth per generation (p=0.0119 and p<0.0001, respectively). By generation 8, the minimum, maximum and average growth had decreased by 18%, 23% and 23%, respectively, as compared to the first, random generation. The overall decrease in growth per generation was 0.04 OD units.

To account for between generation experimental variability, the experiments for the best and median consortium of each generation were repeated, both in a single batch, with each consortium within a batch performed in triplicate. For each generation, the best consortium was the one with the lowest OD value and the solution that ranked at position 10 in a list sorted according to increasing OD values was chosen as the median consortium. There was a significantly decreasing trend in growth through the generations for both these batches (p<0.0001 for both), which confirmed the previously observed trends.

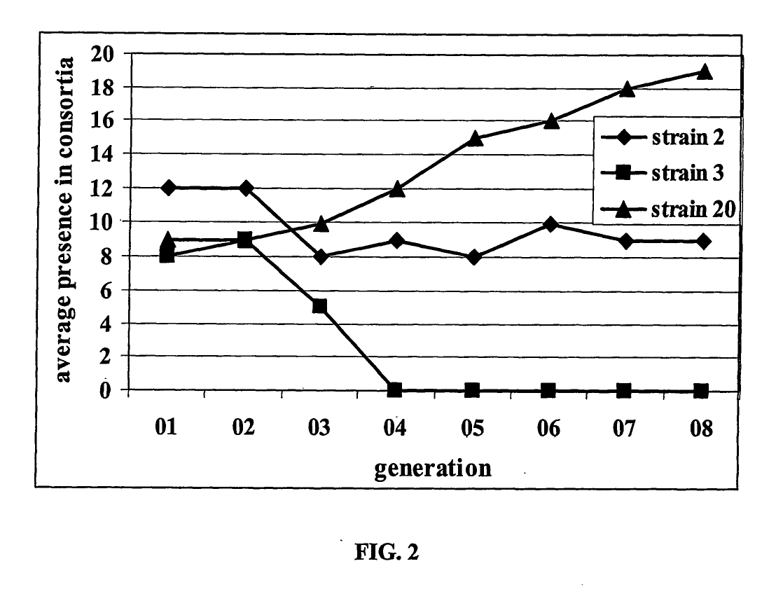

For some strains, clear trends were visible in the average number of times they were present in the different consortia of each generation. For example, as shown in FIG. 2, some strains (e.g. strain 20) were clearly positively selected by the algorithm while others (e.g. strain 3) were eliminated from the population. This suggests that the respective negative or positive contribution of these strains to the growth of the consortia of which they are members was very pronounced regardless of their possible interactions with the other members of each consortium. On the other hand, the frequencies of some strains (e.g. strain 2) did not show a clear upward or downward trend. This might suggest that the effect of such strains on the growth of the consortia of which they are a member was dependent on the presence or absence of other strains or that these strains had a neutral effect on overall growth.

The structures (strain compositions) of the individuals (consortia) of generation 9, the last calculated generation, are listed in Table 1 below. In this table and others that follow, the structure is the “chromosome” encoding the composition of the particular microbial consortium, where each position in the string of numbers denotes a different organism and a “1” in the position indicates that the organism is present and a “O” indicates that the organism is absent.

TABLE 1
Composition of Generation 9

| | | | |
|---|---|---|---|
| Individual | Structure | Individual | Structure |

| | | | |
|---|---|---|---|
| 1 | 11000110101000111001 | 11 | 11000000001000111101 |
| 2 | 00010000001001001101 | 12 | 00010001001000111111 |
| 3 | 00010001001010001100 | 13 | 11010000001000111001 |
| 4 | 10010000001000111111 | 14 | 00010001001000111101 |
| 5 | 10011110101001111101 | 15 | 00011100111001011101 |
| 6 | 11000110001110011101 | 16 | 11010101001110101111 |
| 7 | 00010001001000111101 | 17 | 00010101111001011101 |
| 8 | 10010000001000011101 | 18 | 11110000000011001101 |
| 9 | 10011110001110011001 | 19 | 11000101001000101101 |
| 10 | 11000110101000111101 | 20 | 11010110101001111101 |

Several conserved regions within the chromosomes (representing strains whose presence in each of the 20 consortia was conserved as the method generated successive solutions to the constraint of minimal growth) are apparent, even though the population does not seem to be at full convergence.

The structure (strain composition) of the best individual (consortium) in each of the 8 calculated generations (the first was randomly chosen) is given in Table 2:

TABLE 2
Best Individual In Each Generation

| | |
|---|---|
| Generation | Structure |

| | |
|---|---|
| 1 | 11110101101000111101 |
| 2 | 11010101101000111101 |
| 3 | 11001110101001101111 |
| 4 | 11010101001000111101 |
| 5 | 00010000001000111101 |
| 6 | 00010000001100111101 |
| 7 | 00010001001000111111 |
| 8 | 11000110101000111001 |

Again, conserved regions (indicating similar strain composition) within the chromosomes representing were apparent. It also appears that the GA quickly eliminated certain strains from the consortia. These could be strains that have a dominating overall positive effect on growth of the consortia of which they are a member. On the other hand, some strains seemed to be positively selected. These could be strains that have an overall negative effect on growth. Possibly, the algorithm is also seeking out clusters of organisms that together exhibit low growth. Regardless, the algorithm can identify consortia that grow less than the individual members of the consortia grow separately. Such consortia may find application as protective biofilms.

In summary, the use of a genetic algorithm to construct microbial consortia from separate isolated fast growing strains was successful in decreasing levels of growth through the generations. Within 8 generations (160 evaluations), a set of consortia was obtained of which the minimal growth had decreased by 18% and the average growth by 23% as compared to a first random set of consortia. This example demonstrates that evolutionary computation can be used to design ecosystems to optimally perform arbitrary predetermined functions that are not possible using classical enrichment techniques, and that the disclosed methods can be used to provide useful consortia for both industrial tasks (such as in fermentation and bioreactor applications) and for fundamental ecological studies (such as for studying detrimental interactions between organisms).

### EXAMPLE 2

### Constructing Microbial Consortia for Increased Biomass Production

This example describes the use of a genetic algorithm (GA) to construct microbial consortia with increased biomass production from isolated strains of bacteria. The method provided a set of consortia within 19 generations (380 evaluations) for which the maximal biomass production had increased by 170% and the average biomass production had increased by 138% as compared to a first set of randomly generated consortia.

Microbial isolates with morphologically distinct colony features were obtained by incubating a dilution of a surface layer soil sample on R2A agar and incubating the plates at different temperatures. From these isolates, 20 different fast growing strains were selected that had grown well in an overnight Luria Bertani (LB) broth culture, as judged by the turbidity of the culture medium. An equal volume of 40% glycerol was added to the cultures (final concentration 20% glycerol), after which they were aliquoted in cyrovials and stored at −80° C.

The GA used in this example followed the generational model and had a population size of 20 individuals. Each solution (“individual”/consortium of different strains) was represented as a string of 20 bits, encoding the presence or absence of a particular microorganism. In this way, each solution encoded for a specific microbial consortium. The first generation was randomly generated. Fitness values were linearly rescaled, with μ′=μ and fₘₐₓ′=2μ. If this yielded negative values, the fitness values were rescaled so that μ′=μ and f′ₘᵢₙ=0. Roulette Wheel selection was used and no elitism was applied. Single crossover was performed on each pair of selected individuals with a probability of 0.90. Mutation was performed by flipping bit values with a probability of 0.01 per bit 21 generations in total were evaluated, including the initial randomly generated consortia.

The objective of this optimisation effort was to obtain a consortium with an optimal dry biomass production. To evaluate the fitness of the individuals in a given generation provided by the GA, the corresponding microbial consortia were assembled and incubated as follows. First, the separate strains were diluted from their stock vials by adding 50 μL of each to 3 mL of LB medium. The 20 consortia of each generation including subsets of the 20 strains were then constructed in 20 standard glass test tubes by transferring 100 μL volumes of the appropriate strains into the 20 consortium tubes. After this, LB was added to the consortium tubes to bring all volumes up to 6 mL. Each consortium was then made in triplicate by first vortexing its tube and then transferring 2 mL to each of two empty glass test tubes. 3 mL of LB was added to all tubes so the final volume of all test tubes was 5 mL. The 60 (3×20) tubes making up one generation were incubated at 37° C. and 200 rpm for 24 hours. After this, the cells in the broth were spun down and dried overnight at 55° C. Dry biomass production was measured by determining the mass of the dry pellets. The fitness value of each individual in the GA was calculated as the average dry biomass production by the corresponding consortium for the three replicates. As a measure for the reproducibility of this experimental method, the standard deviation on the three replicates averaged over all 400 (20 individuals×20 generations) evaluations was 0.000343 g.

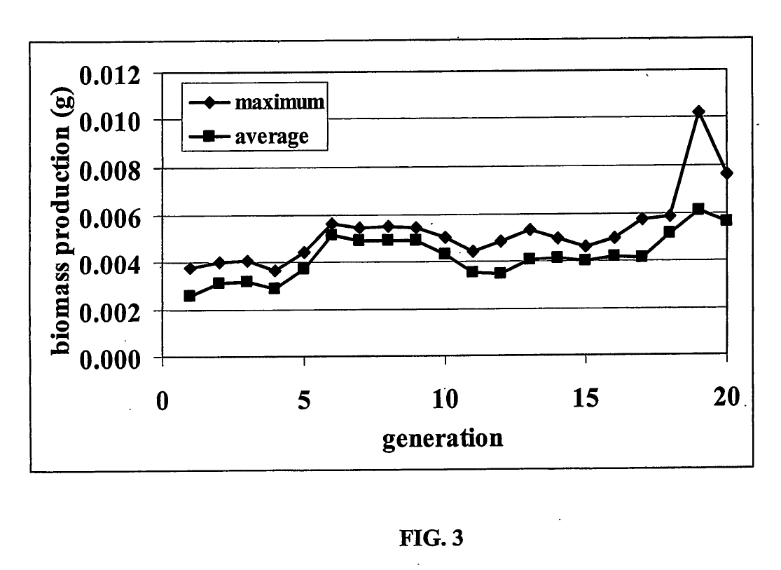

As shown in FIG. 3, the biomass production generally increased in successive generations. In particular, the biomass production fitness values were significantly increased in generation 19 as compared to the first generation (p˜0.015 and p<0.001, respectively). By generation 19, the maximum fitness had increased by 170% and the average fitness by 138% as compared to the first, random generation.

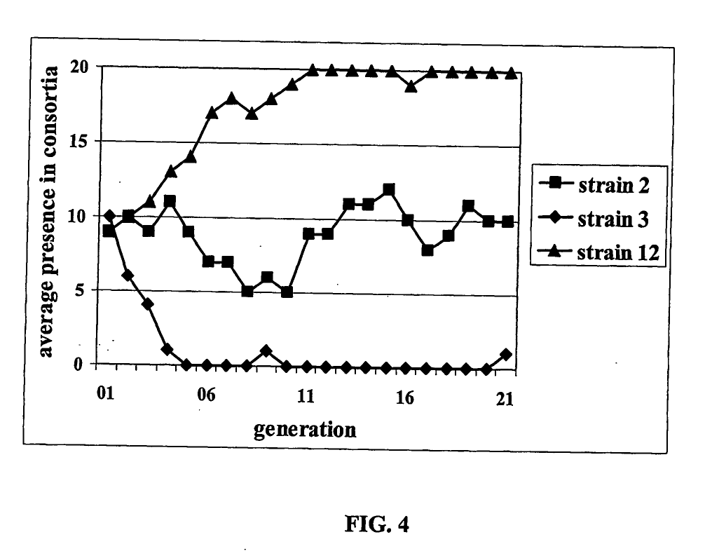

For some strains, clear trends were visible in the average number of times they were present in consortia of each generation. As shown in FIG. 4, some strains (such as strain 12) were positively selected by the algorithm while others (such as strain 3) were gradually eliminated from the population. This may suggest that the respective positive or negative influence of these strains on the performance of the consortia of which they are a member is very pronounced regardless of their possible interactions with the other members of each consortium. On the other hand, the frequencies of some strains (such as strain 2) did not show a clear upward or downward trend. This may suggest that the influence of these strains on the consortia depends on the presence or absence of other strains.

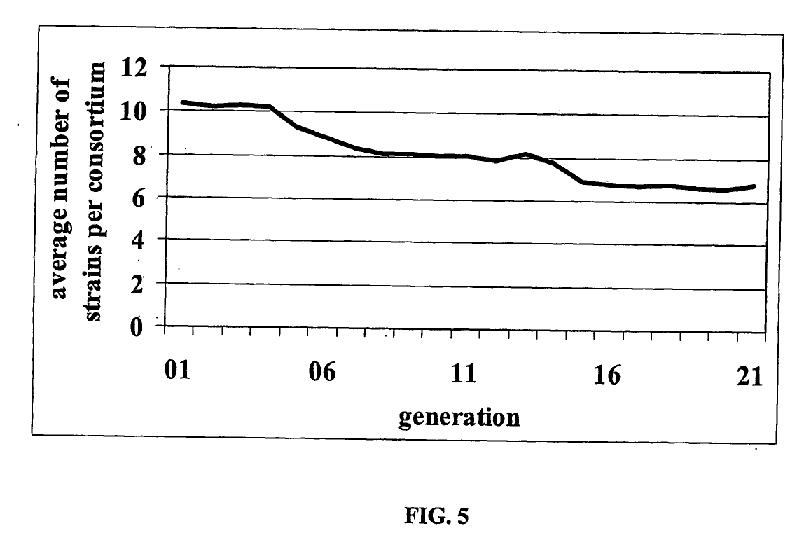

The trend in the average number of strains per consortium through the generations is depicted in FIG. 5. As shown, the algorithm selected a lower number of strains per consortium over the generations. The distinct stepwise character of this trend may indicate that the algorithm explored different local optima in the fitness landscape.

The composition of generation 21, the last calculated generation, is listed in Table 3 below:

TABLE 3
Composition of Generation 21

| | |
|---|---|
| INDIVIDUAL | STRUCTURE |

| | |
|---|---|
| 1 | 01000000101100000000 |
| 2 | 11001101100110000011 |
| 3 | 11000000100100000011 |
| 4 | 00000101100101000111 |
| 5 | 00000100101100000001 |
| 6 | 01000100101110000001 |
| 7 | 00001101100110000011 |
| 8 | 01000100100100000011 |
| 9 | 00000000101100000000 |
| 10 | 01000111100111111011 |
| 11 | 11000000100110000001 |
| 12 | 00001111101100000000 |
| 13 | 00001111100110000001 |
| 14 | 00000100100100000011 |
| 15 | 00000100100110000001 |
| 16 | 00001100101100000011 |
| 17 | 01100000100100000011 |
| 18 | 11000000101100000000 |
| 19 | 00000111100100000011 |
| 20 | 11000000100111110011 |

Several conserved regions within the chromosomes are apparent, indicating that certain strains were favored components of the optimized consortia, and in particular components of the best consortia of each generation. The structure of the best individual in each calculated generation is given in Table 4:

TABLE 4
Best Individual In Each Generation

| | |
|---|---|
| GENERATION | STRUCTURE |

| | |
|---|---|
| 1 | 10011101000000010000 |
| 2 | 10011000101111010100 |
| 3 | 10000100100111110000 |
| 4 | 11011101000000010000 |
| 5 | 01000010010111110000 |
| 6 | 10000100010101110010 |
| 7 | 00000100100111110000 |
| 8 | 00000101101100000011 |
| 9 | 00000011100101110010 |
| 10 | 00000100111101100011 |
| 11 | 00000011100111110000 |
| 12 | 01000000100100000010 |
| 13 | 01000000100100000010 |
| 14 | 01000000101100000011 |
| 15 | 01000000100100000010 |
| 16 | 01000000100100000010 |
| 17 | 11000000101100000010 |
| 18 | 11000000101100000001 |
| 19 | 11000000101100000000 |
| 20 | 11000000101100000000 |

Conserved regions (certain strains) within the chromosomes (that is “individuals,” or in this case particular consortia) are apparent in a comparison between the best consortia (individuals) of each generation.

The trends and patterns in the data presented above appear to show that as the algorithm assembled more highly productive microbial consortia over the generations, certain strains were quickly eliminated. These may be strains that have a dominating overall negative influence on the productivity of the consortia when they are present. Other strains seemed to be quickly selected for inclusion in successive generations. These could be strains that have high biomass production and an overall positive influence on the consortia when they are present. It is also possible that the algorithm is seeking out clusters of highly productive organisms (building blocks) that function well together and is then recombining these clusters into larger scale consortia. Such groups of organisms could have a high biomass production because they have a positive influence on each others growth or because they target different ranges of nutrient sources within the LB broth. Regardless of the underlying mechanisms, the algorithm identified progressively better and better consortia for performing a particular function, in this case biomass production.

### EXAMPLE 3

### Constructing Microbial Consortia for Degradation of Azo Dyes

In this example, a genetic algorithm is used to artificially construct a microbial consortium to optimally perform another arbitrarily chosen ecological function, in this case degradation of the azo dye Orange II. This example demonstrates the use of the disclosed methods for providing consortia that can be used for bioremediation.

40 microbial isolates with morphologically distinct colony features were obtained by incubating dilutions of a small amount of soil on R2A agar at different temperatures. Glycerol stocks of the isolates were stored at −80° C.

The GA used here followed the generational model and had a population size of 24. Each solution was represented as a string of 40 bits, encoding the presence or absence of the corresponding microorganism. In this way, each solution encoded for a specific microbial consortium. The first generation was randomly generated. Fitness values were linearly rescaled, with μ′=μ and fₘₐₓ′=2μ. If this yielded negative values, the fitnesses were rescaled so that μ′=μ and f′ₘᵢₙ=0. Roulette Wheel selection was used, and no elitism was applied. Single crossover was performed on each pair of selected individuals with a probability of 0.90. Mutation was performed by flipping bit values with a probability of 0.01 per bit.

To evaluate the fitness of each individual (consortium) in a generation, a 96 well plate was filled with 200 μL of LB medium containing 130 mg/L of Orange II. Each of the 24 consortia was constructed in fourfold in the wells on the plate by inoculating each well with the appropriate strains from the cryovials using sterile toothpicks. The plate was then covered with a non-breathable membrane, and statically incubated at 37° C. in an automated plate reader for 48 h. The absorbance in each well at the absorption maximum of the dye was measured every 15 minutes. For each well, the initial and final dye concentration was calculated using a standard curve and the percentage of dye breakdown was determined. The fitness of each individual was then calculated as the average fraction of dye that was broken down in the four replicates after 48 h.

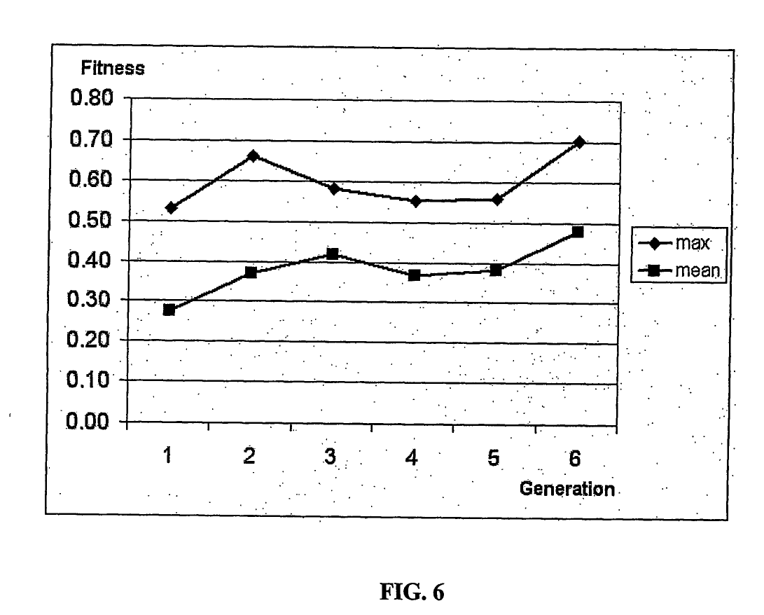

The trends in maximum and mean fitness over the course of 6 generations are shown in FIG. 6. After only 6 generations, the maximum fitness (ability to degrade the dye) increased by 32% and the mean fitness by 75% as compared to the first, random generation.

For some strains, clear trends were visible in the number of times they were present in each generation. For example, some strains were positively selected by the algorithm while others are gradually eliminated. This suggests that the respective positive or negative influence of the presence of these strains on the performance of the consortia of which they were members is very pronounced regardless of their possible interactions with the other members of each consortium. On the other hand, the frequencies of some strains did not show a clear upward or downward trend, suggesting that the influence of these strains on the consortia depends on the presence or absence of other strains.

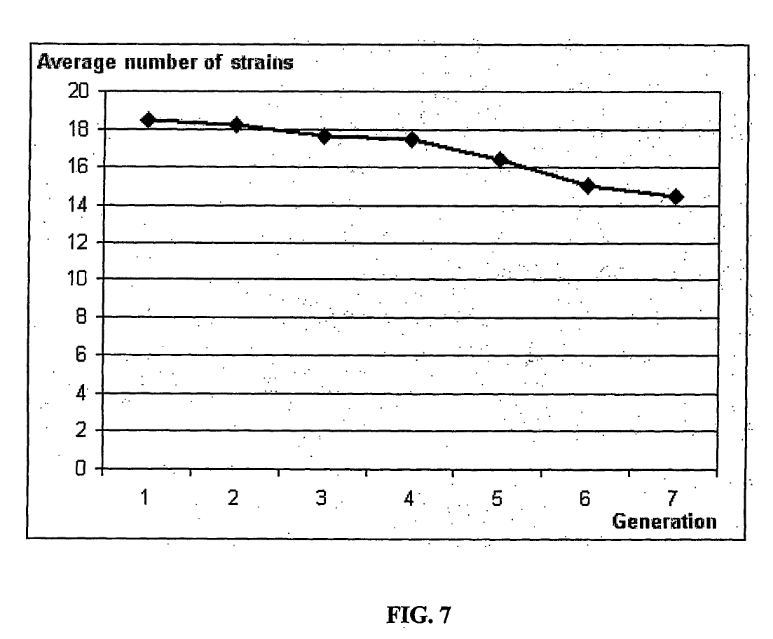

The trend in the average number of strains per consortium through the generations is depicted in FIG. 7. As shown, the algorithm selected for a lower number of strains per consortium. It is possible that this is an indication of an underlying ecological principle governing this system.

The structure of the best individual in each generation and its corresponding fitness are given in Table 5 below:

TABLE 5
Fitness and Structure of Best Individuals

| | | |
|---|---|---|
| GENERATION | FITNESS VALUE | STRUCTURE |

| | | |
|---|---|---|
| 1 | 0.5299 | 0110000110111000011110101100011111111100 |
| 2 | 0.6616 | 1011000011000001010100010100001000000010 |
| 3 | 0.5835 | 1110000010100010000001000000010011001101 |
| 4 | 0.5533 | 1110000010100010000001000000010110101111 |
| 5 | 0.5615 | 0110000010100010000010000001000110100001 |
| 6 | 0.7010 | 1110000011000001010100010100001000000010 |

The listed structures show that conserved regions (certain strains) within the chromosomes (consortia) have begun to recur even after only 6 generations. This was also observed in the overall composition of the last generation (data not shown). Surprisingly, even without elitism, the structure of the best individual of generation 2 reappeared as the structure of the best individual of generation 6, with two adjustments, yielding an even better fitness.

### EXAMPLE 4

### Constructing Microbial Consortia of Cyanobacteria for Optimal Biomass Production

A GA is used to optimize a consortium of cyanobacteria for optimal biomass production (carbon sequestration) by combined photosynthesis and nitrogen fixation. The optimization process is characterized at the genetic level. Therefore, a fully-sequenced strain (Nostoc puctiforme ATCC 29133) is employed as a member of the initial population being optimized.

39 cyanobacterial strains are isolated from natural waters and lithic ecosystems capable of nitrogen fixation and having distinct 16S rDNA signatures. Addition of Nostoc puctiforme ATCC 29133 gives a total of 40 strains. The GA is used to artificially construct a consortium from the 40 strains such that the consortium is optimized for biomass production from CO₂ and N₂ at standard atmospheric concentrations and mesophilic temperatures (25-30° C.). An algorithm and methods similar to those described in Example 2 are used, but substituting an ATCC medium 819 (blue-green nitrogen-fixing medium).

The species diversity of the artificial consortia during the GA-based optimization process and at the optimized end points are quantitatively characterized. This entails a determination of the presence/absence and number of each of the original 40 strains, including Nostoc puctiforme ATCC 29133. Simultaneously, the occurrence and distribution of important Nostoc puctiforme ATCC 29133 genes within community members are measured to observe processes such as horizontal gene transfer, gene duplication, gene elimination, and/or gene over-expression that might be involved in efficient carbon sequestration by the optimized consortium. Genes of particular interest include N. puctiforme-specific nif markers and genes involved in carbon fixation. These experiments are performed using viable counting techniques (to determine strain selection by the GA) alongside quantitative genetic techniques such as qPCR (real-time PCR) to measure gene copy numbers and their redistribution within the consortium.

### EXAMPLE 5

### Constructing Microbial Consortia for Chlorophenol Remediation

This example describes another use of a genetic algorithm to artificially construct a microbial consortium from separate isolated strains to optimally perform a specifically chosen ecological or industrial function. In this instance, a GA is used to find combinations of organisms that together form communities that optimally perform a specific industrially valuable process, namely, to find a subset(s) of a set of microbial soil isolates that will optimally degrade the toxic xenobiotic chemical pentachlorophenol (PCP), a highly toxic US EPA priority pollutant frequently associated with chemical contamination of soil and water by wood-treatment facilities. Consortia that degrade other xenobiotic compounds such as polynuclear aromatic hydrocarbons (PAHs) and herbicides are also identified, and several evolutionary computation methods are used as alternative methods to select optimized consortia for degrading these xenobiotics. This example also demonstrates that the disclosed methods can be used in combination with classical enrichment techniques, which may be used to provide optimized strains for inclusion in the artificial consortia generated by the methods.

A GA is used to construct a microbial consortium that is optimized for the degradation of pentachlorophenol (PCP). It is derived from a mixture of pure cultures isolated from a PCP-contaminated soil, and the genomic diversity of optimized consortia are then characterized.

40 microbial strains with distinct morphological (colonial or cellular) and genetic (16S rDNA signatures) features are isolated from a PCP-contaminated soil sample, and these strains are characterized as to their phylogenetic affiliations. The 40 microbial isolates with morphologically distinct colony and/or cellular features or 16S rDNA sequences are obtained by incubating dilutions of a PCP-contaminated soil sample on a defined mineral medium at pH 7.5 that contains sodium glutamate (20 g/L), yeast extract (0.1 g/L), and PCP (50 mg/L), and agar (15 g/L) (Glutamate-YE-PCP). This medium is known to support the growth of a variety of PCP-degrading bacteria. Additional strains are isolated by selection on trypticase soy agar (TSA) plates containing 100 ppm of PCP. Selection plates are then incubated at different temperatures between 10° C. and 50° C. to encourage isolation of a large variety of PCP-metabolizing strains for inclusion in artificial consortia. Glycerol stocks of the isolates are prepared and stored at −80° C.

The pure cultures are then characterized as to their closest known phylogenetic affiliations by using PCR to amplify their 16S rDNA genes, sequencing the PCR products, and comparing the sequences to known sequences in databases at the National Center for Biological Information (NCBI) using BLASTN 2.2.6 (30). Prior to PCR cells are lysed directly by boiling a suspension of the bacterial cells (50 μl) to which is added 100 μl TE buffer (pH 8) containing 1% Triton-X 100 (final concentration; v/v). The suspension is boiled for 10 minutes in a water bath, cooled for 1 minute, and vortexed. Cell debris is removed by centrifugation at 3,000×G for 15 seconds, and 2 μl of the supernatant is used directly for PCR. Each 50 μl PCR reaction contains the following components: HPLC-grade water up to volume, 1/10 volume of 10×PCR buffer (Promega, Madison, Wis.), MgCl₂ (2 μM) (Promega, Madison, Wis.), deoxyribonucleotide triphosphates (dNTPs, 0.2 mM) (Gibco BRL), 1× bovine serum albumin (1 μl) (Boeheringer Mannheim), forward and reverse primers (0.5 μM each) (Gibco BRL), Taq DNA polymerase (1.25 U) (Promega, Madison, Wis.), and 2 μl of prepared cell extract. Universal eubacterial primers 338f (5′-ACT CCT ACG GGA GGC AGC-3′) and 907 reverse (5′-CCG TCA ATT CMT TTR AGT TT-3′) (33) are used, with M being a 1:1 Mixture of A and C. The PCR protocol used for eubacterial samples consists of a 5 minute denaturation step at 95° C., followed by 32 cycles of denaturation (45 s, 95° C.), primer annealing (45 s, 55° C.), and primer extension (45 s, 72° C.), finishing with a final extension step (5 min, 72° C.). The presence of appropriately sized PCR products is visualized on 1% agarose gels. PCR products are purified from PCR reaction mixtures using the Qiaquick PCR Purification Kit (Qiagen) and sequenced using well-known methods.

A GA is used to artificially construct a consortium from the 40 isolates such that the consortium is optimized for the biodegradation of PCP as follows. The GA uses a generational model with a population size of 24. Each solution is represented as a string of 40 bits, encoding the presence or absence of each of the isolated microorganisms in the artificial consortia. In this way, each solution encodes for a specific microbial consortium. The first generation is randomly generated. Fitness values are linearly rescaled, with μ′=μ and f_{max′}=2μ. If this yields negative values, the fitnesses are rescaled so that μ′=μ and f′ₘᵢₙ=0. Roulette Wheel selection is used and no elitism is applied. Single crossover is performed on each pair of selected individuals with a probability of 0.90. Mutation is performed by flipping bit values with a probability of 0.01 per bit. In other embodiments, elitism is used to increase the efficiency of the optimization. Robotic equipment is used to measure the fitness values of the large number of candidate solutions generated with the increased population size.

To evaluate the fitness (PCP degradation rate/extent) of each individual in a generation, a 96 well plate is filled with 200 μL of glutamate-YE medium containing 50 mg/L of PCP. Each of 24 consortia is constructed fourfold in wells on the plate by inoculating each well with the appropriate strains from the cryovials using sterile toothpicks. The plate is covered with a non-breathable membrane, and incubated in a shaker specifically designed for microtiter plates (Gene Machines, HighGrow) at 37° C. After an appropriate period of growth (such as 12-24 hours) the plates are centrifuged to pellet the cells, the supernatants are transferred to a new plate, and then placed in a microtiter plate reader (FluorMax-3). The absorbance in each well recorded at the absorption maximum (320 nm) of PCP is measured.

For each well the initial and final PCP concentration are calculated using a standard curve and the percentage of PCP breakdown is determined. The fitness of each individual (consortium) is then calculated as the average fraction of PCP that was broken down in the four replicates during the incubation period. Alternatively, high-throughput liquid chromatography (HPLC) is used to quantitate the PCP.

A subsequent batch of experiments is derived (designed) from each previous set of experiments using a genetic algorithm. From the experimental results, a fitness value is calculated for each consortium in the set and that value is rescaled. From the current set, a new set of consortia is selected using roulette wheel selection. The selected consortia are paired two by two, after which single crossover and mutation are applied. If applied, elitism is then used. The optimization is repeated 3-5 times to determine if a similar end point is reached each time, or if the outcome (optimized culture composition) is variable.

As a control, a traditional enrichment culture for PCP degradation is generated by adding all 40 pure strains to a flask of glutamate-YE-PCP medium and incubating this at 37° C. with shaking, transferring the culture through at least 10 passages. The ultimate enriched culture is then examined for its PCP degradation fitness and its final microbiological composition.

Using standard procedures, a 16S rDNA library is produced from the total community DNA of the consortium at the end of the optimization process. The library is generated by PCR from total consortium DNA using primers specific for Eubacteria (338f forward primer 5′-ACT CCT ACG GGA GGC AGC-3′ and 907 reverse primer 5′-CCG TCA ATT CMT TTR AGT TT-3′) with M being a 1:1 Mixture of A and C (33); 100-200 clones will be prepared for the library. Clones from the artificially constructed consortia are sequenced.

Once the dominant members of the consortium have been identified qualitatively, their relative abundances as compared to each other is determined. Members of the consortia that are morphologically distinct are enumerated by plate counting procedures on glutamate-YE-PCP agar and TSA agar. Quantitative PCR (Real Time PCR also called qPCR; 35) is also used to compare strain abundances. Standard curves for qPCR are prepared using purified 16S rDNA PCR products obtained from the clone libraries obtained from the consortium. The number of gene copies/mL for each strain within the end-point consortium will then be determined by qPCR. A GA is also used to optimize degradation of additional xenobiotic compounds by artificial consortia constructed from known pure cultures of microorganisms inhabiting chemically-contaminated soil. The methods employed are similar to those described above for the optimization of PCP degradation. The additional compounds to be examined include polynuclear aromatic hydrocarbons (such as naphthalene and pyrene found in contaminants such as creosote) and herbicides (such as the common toxic groundwater contaminant Atrazine). Additional evolutionary optimization algorithms are also used to optimize the microbiological biodegradation processes. In particular, using PCP as the model xenobiotic compound Genetic Programming, Evolution Strategies and Evolutionary Programming are used to construct optimized consortia, and these are compared to the optimal consortium identified using the genetic algorithm.

The xenobiotic compound degradation rates of GA-optimized consortia are statistically compared to those observed for the initial randomly generated consortia and/or consortia generated by traditional enrichment techniques. The use of GAs and other evolutionary computation methods to optimize biodegradation processes is generally useful as a means for industry to improve microbiological processes such as are used in hazardous waste treatment systems.

### EXAMPLE 6

### Application of the Disclosed Methods/Alternative Embodiments

As shown above, evolutionary computation techniques can be used to construct efficient real world biological ecosystems. This example, discusses various aspects of using the disclosed methods in general, and in particular for ecological research.

Organisms live in complex ecological systems, which can have high levels of non-linear interaction. The actions of every member of an ecosystem can be advantageous, disadvantageous or neutral for one or more of the other members and organisms can form intricate interacting networks with each other. In addition to this, experimental ecological data is often rather noisy in nature. These elements make the study of ecosystems particularly challenging and trying to deliberately assemble ecosystems with a particular predetermined function is seldom attempted.

Evolutionary computation (EC) offers a range of flexible and robust search and optimization techniques capable of dealing with noisy and nonlinear systems, and can be used on systems without knowing the exact governing dynamics, in a sense, treating systems as black boxes.

Traditionally, researchers interested in a particular ecological process would seek out efficient ecosystems in nature and then try studying those. The disclosed methods are a tool to predefine a process of interest and then construct ecosystems that efficiently perform this process from arbitrary sets of candidate organisms.

Even though changes in ecosystem composition are not considered to be evolution in the strictest sense, the environment selects for the composition of ecosystems. In nature, environmental conditions represent a selective pressure that will result in the ecosystems (metagenomes) best adapted to those particular conditions. Constructing efficient ecosystems using EC can be regarded in the same way, but it also goes further. Using EC, it's actually possible to obtain ecosystems that perform functions that can not be selected for in nature. An example of this is given in Example 1 above, where minimal biomass production was selected.

There are three main types of ecosystem assembly, each of which can be optimized using EC. The most straightforward method of assembly is combining fixed amounts of different organisms together at one single point in time. A bit string, encoding for the presence or absence of corresponding organisms can represent an ecosystem as the subset of organisms from a set of candidate organisms. An elaboration on this basic idea is to allow the number of organisms of each species to be added to an ecosystem to vary. Such ecosystems can also be represented as bit strings, with subsections of the strings mapping to amounts of organism, or as a string of integer or real values. While in the previous two types of ecosystem assembly, all organisms are combined at one point in time, a third type defines the point in time at which each species is added to the ecosystem and thus also the sequence of additions. This can be combined with either fixed or variable amounts of organism to be added.

An important part of using EC to construct ecosystems as disclosed is that fitness values of solutions (sets of organisms) are determined experimentally. To asses how well a particular subset of organisms or an ecosystem performs a predetermined function, that ecosystem is assembled in a controlled environment, after which fitness values are measured. While it is desirable to increase population size, assembling ecosystems for fitness evaluation can be labor intensive, so robotic equipment can be used.

Hybrid optimization techniques that employ elements from EC combined with traditional modeling can be used in the disclosed methods. In such cases, modeling or interpolation can help in reducing the number of fitness evaluations that are performed, Additional optimization techniques that may be combined with EC include random searches, hill climbing, neural networks, particle swarm optimization and simulated annealing. Alternatively, multiple EC methods can be combined, for example, alternately in successive iterations of the disclosed method.

A metric for assessing the success of an optimization run is as follows. Using fitness values obtained from randomly generated ecosystems, it is possible to determine the distribution of fitness values under random conditions. It is also possible to calculate the number of random experiments that need to be performed to have a 95% chance of obtaining at least the highest fitness value of the EC optimization technique. If this number is higher than the total number of optimization evaluations, then the optimization technique can be considered to be more efficient than a random search.

Using optimization techniques such as EC techniques to construct efficient ecosystems helps with an understanding of the processes taking place in ecosystems. Once an efficient combination of organisms has been identified, additional work can be done to remove the organisms with only a neutral effect. Studies of metabolism and population dynamics can then be performed on that reduced set of core organisms to identify the biological mechanisms leading to the overall efficiency.

Having illustrated the method by way of example, it should be understood that the scope of the invention is not limited by the particular examples provided. It will be apparent to those of ordinary skill in the art that variations of the particularly disclosed embodiments may be used, and it is intended that the disclosure may be practiced otherwise than as specifically described herein. Accordingly, this disclosure includes all modifications encompassed within the spirit and scope of the disclosure as defined by the following claims.

I claim:

1. A method for selecting a group of organisms to perform a predetermined function, comprising:
measuring fitness values for performing the predetermined function for a first set of candidate groups of organisms;
deriving a second set of candidate groups of organisms from the first set using an optimization technique, the optimization technique using the fitness values of the groups in the first set to select the second set of groups;
measuring fitness values for performing the predetermined function for the groups in the second set; and
selecting a group of organisms from the second set of candidate groups of organisms to perform the predetermined function, wherein the group of organisms selected from the second set has a higher fitness value for performing the predetermined function than groups of organisms in the first set.

2. The method of claim 1, wherein the candidate groups of organisms also comprise amount and/or sequence of introduction information for the organisms in the group.

3. The method of claim 1, wherein the optimization technique comprises evolutionary computation.

4. The method of claim 3, wherein the evolutionary computation comprises a genetic algorithm, an evolution strategy, a genetic program, an evolutionary program, or an evolutionary algorithm.

5. The method of claim 4, wherein the evolutionary computation comprises a genetic algorithm.

6. The method of claim 1, wherein the first and second sets of candidate groups of organisms comprise microbial consortia.

7. The method of claim 1, wherein the first and second sets of candidate groups of organisms comprise groups of crop plants for intercropping.

8. The method of claim 1, wherein the predetermined function comprises an ecological function.

9. The method of claim 8, wherein the ecological function comprises increased or decreased diversity, biomass production, exploitation of available resources, stimulation of growth of other organisms, or inhibition of growth of other organisms.

10. The method of claim 1, wherein the predetermined function comprises an industrial function.

11. The method of claim 10, wherein the industrial function comprises energy production, a chemical reaction, bioremediation, biodegradation or waste recycling.

12. A method for selecting a consortium of microorganisms to perform a predetermined function, comprising:
generating an initial population of chromosomes, the chromosomes encoding groups of microorganisms selected from a panel of microorganisms;
determining fitness values for performing the function for the groups encoded by the chromosomes;
selecting chromosomes from the initial population in proportion to their fitness values;
exchanging pieces of the selected chromosomes and mutating the selected chromosomes to produce a second population of chromosomes;
determining fitness values for performing the function for the groups encoded by the chromosomes in the second population; and
selecting to perform the function a group encoded by a chromosome in the second population having a fitness value greater than one or more other groups encoded by chromosomes in the second population.

13. The method of claim 12, wherein the chromosomes further encode information on the relative amounts and/or sequence of introduction of the organisms encoded by the chromosomes.

14. The method of claim 12, wherein the function comprises biomass production, fermentation, biodegradation or bioremediation.

15. The method of claim 14, wherein the function comprises biomass production.

16. The method of claim 12, wherein the function comprises bioremediation.

17. The method of claim 16, wherein the function comprises bioremediation of an azo dye or pentachlorophenol.

18. A method for selecting a group of organisms to perform a predetermined function, comprising:
selecting an initial set of candidate groups of organisms, where the individual organisms in the groups of organisms in the set are selected from a panel of organisms;
selecting a second set of candidate groups of organisms for the purpose of performing the function using a genetic algorithm, the genetic algorithm using experimentally determined fitness values determined for the groups of organisms of the initial set to select the second set;
determining fitness values for the second set of candidate groups of organisms; and
selecting a group of organisms to perform the function from the second set of candidate groups of organisms.

19. The method of claim 18, wherein the panel or organisms comprises a panel of microorganisms.

20. The method of claim 18, wherein the groups of organisms are microbial consortia.

21. The method of claim 18, wherein the candidate groups further comprise amount and/or sequence of introduction information for the organisms in the candidate groups.
